(19) United States
(12) Patent Application Publication
(10) Pub. No.: US 2014/0186734 A1
(43) Pub. Date: Jul. 3, 2014

(54) DIAGNOSTIC AND HEAT MANAGEMENT SYSTEM FOR FUEL CELL STACK

(71) Applicants: Kangnam University Industry-Academia Cooperation Foundation, Yongin (KR); Hyundai Motor Company, Seoul (KR)

(72) Inventors: Kwi Seong Jeong, Yongin (KR); Sae Hoon Kim, Yongin (KR); Uck-Soo Kim, Anyang (KR); Hyun-Seok Park, Gunpo (KR); Young-Hyun Lee, Yongin (KR)

(73) Assignees: Kangnam University Industry-Academia Cooperation Foundation, Yongin (KR); Hyundai Motor Company, Seoul (KR)

(21) Appl. No.: 14/136,881

(22) Filed: Dec. 20, 2013

(30) Foreign Application Priority Data
Dec. 27, 2012 (KR) 10-2012-0155396

(51) Int. Cl. H01M 8/04

(52) U.S. Cl. CPC H01M 8/04559; H01M 8/04589
USPC 429/431

(57) ABSTRACT

A diagnostic and heat management system for a fuel cell stack is provided herein that includes a diagnostic control analyzer that diagnoses and analyzes a state of the fuel cell stack by measuring a voltage and a current of the fuel cell stack. Also, an AC signal generator generates a diagnostic AC signal, and an AC component driving element that is included in an AC component in a current of the fuel cell stack. Additionally, a termoelement is driven as a heat absorbing device when a temperature of the AC component driving element is equal to or greater than a predetermined temperature and is driven as a heat emitting device when a temperature of the AC component driving element is less than a predetermined temperature, in order to manage heat generation in the AC component driving element.

### CROSS-REFERENCE TO RELATED APPLICATION

This application claims priority to and the benefit of Korean Patent Application No. 10-2012-0155396 filed in the Korean Intellectual Property Office on Dec. 27, 2012, the entire contents of which are incorporated herein by reference.

### BACKGROUND

(a) Field of the Invention

The present invention relates to a diagnostic and heat management system for a fuel cell stack that can diagnose a fuel cell stack and efficiently manage a heat generating due to the diagnostic process.

(b) Description of the Related Art

A fuel cell is a device that converts the chemical energy from a fuel into electricity through a chemical reaction with oxygen or another oxidizing agent. Hydrogen is the most common fuel, but hydrocarbons such as natural gas and alcohols like methanol are sometimes used. Fuel cells are different from batteries in that they require a constant source of fuel and oxygen to run, but they can produce electricity continually for as long as these inputs are supplied. Fuel cells may be applied to supply industrial, household, and vehicle driving power as well as to supply power to a small-sized electric/electronic product.

For example, one of the ways that a vehicle can be powered is by a fuel cell system such as a polymer electrolyte membrane fuel cell or a proton exchange membrane fuel cell (PEMFC). These types of fuel cells have a higher power density, fast starting time and fast power conversion reaction time at lower operational temperatures.

PEMFCs typically include a membrane electrode assembly (MEA) in which a catalyst electrode layer in which an electrochemical reaction occurs is attached to both sides of a solid polymer electrolyte film in which hydrogen ions move. Also included in the PEMFC, is a gas diffusion layer (GDL) that uniformly distributes reaction gases and transfers generated electrical energy through the cell. A gasket and an engaging device are also typically provided. The engaging device maintains an appropriate engaging pressure and air-tightness of reaction gases and coolant. Also a bipolar plate is also provided to move reaction gases and coolant through the cell.

When assembling a fuel cell stack the gas diffusion layer and the MEA are disposed in the middle of the cell. As a result, the catalyst electrode layers of the MEA, i.e., an anode and a cathode to which a catalyst is applied so that hydrogen and oxygen may react at both surfaces of a polymer electrolyte film, are on the outer surfaces of the MEA. Then the gas diffusion layer and a gasket are stacked on top of the anode and the cathode respectively.

On the outer surface of the gas diffusion layer, a reaction gas (typically hydrogen as a fuel and oxygen or air as an oxidizing agent) is supplied, and a bipolar plate having a flow field through which coolant passes is placed thereon. By forming such a configuration in a unit cell, after a plurality of unit cells are stacked, an end plate for supporting a current collector, an insulation plate, and stacking cells are coupled on the outermost surfaces of the stack. By repeatedly stacking and engaging unit cells between the end plates, a fuel cell stack may be formed.

In order to obtain a potential necessary tor a vehicle to be operated, unit cells should be stacked accordingly a necessary potential, in order to ensure that a sufficient potential is output by the cells.

The potential generated by each unit cell is typically about 1.3 V. Thus, in order to generate power that is necessary to power a vehicle, a significant number of cells must be stacked in series. Thus, determining during a failure which cell is not working appropriately can be time consuming and at times difficult. Thus, fuel cell vehicles require a diagnostic system to identify and determine individual unit failures.

FIG. 1 is a schematic diagram of a diagnostic system of a fuel cell stack. according to an exemplary embodiment of the conventional art. Referring to FIG. 1, the diagnostic system of the fuel cell stack according to the exemplary embodiment of the conventional art includes an alternating current (AC) current injector 20 that injects a diagnostic AC current into a fuel cell stack 10, and a diagnostic analyzer 30 that performs diagnostics on the fuel cell stack 10 by analyzing the change in an AC current as result of the injection of the diagnostic AC current.

Because these types of diagnostic systems generally perform diagnosis through total harmonic distortion analysis (THDA) of a diagnostic AC current signal, the diagnostic analyzer 30 typically includes a harmonic analyzer.

When a diagnostic AC current I_{AC} is injected into the fuel cell stack 10 by the AC current injector 20, the diagnostic AC current I_{AC} is overlapped with a current I_{STACK} of the fuel cell stack 10. Therefore, a diagnostic AC current I_{AC} component is also included in a current I_{LOAD} flowing to a load 40.

When the current I_{STACK} of the fuel cell stack 10 and the diagnostic AC current I_{AC} of the AC current injector 20 are overlapped and thus reach the load 40, the diagnostic analyzer 30 detects a voltage from the fuel cell stack 10, converts and analyzes a frequency of the detected voltage, and diagnoses a state and/or a failure of the fuel cell stack 10.

However, in order to prevent collision with a DC current from the fuel cell stack 10, the AC current injector 20 of a diagnostic system of an exemplary embodiment of the conventional art also generally includes a decoupling capacitor (CT). Because the CT of the AC current injector 20 should pass through a lower frequency of AC current, the CT should have a considerably large capacity. Therefore, the CT of the AC current injector 20 is formed by coupling multiple small capacity capacitors (CN) in parallel. However, due to the large quantity of these capacitors that is required, the overall size of the CT and the cost is greater than is desirable by most automotive manufactures. Additionally, when a diagnostic AC current of the AC current injector 20 passes through the CT, the diagnostic AC signal may be distorted and thus precise diagnostic may not be performed.

The above information disclosed in this Background section is only for enhancement of understanding of the background of the invention and therefore it may contain information that does not form the prior art that is already known in this country to a person of ordinary skill in the art.

### SUMMARY

The present invention has been made in an effort to provide a diagnostic and heat management system of a fuel cell stack having that is capable of economically diagnosing the fuel cell stack without distortion of an AC current while using a more simplified configuration by applying an AC diagnostic signal to a base of a power transistor so that a portion of the current from the fuel cell stack may flow through the power transistor in the form of a sine wave, and is also capable of efficiently performing heat management when diagnosing the fuel cell stack by efficiently managing (e.g., using a thermoelement as a heat absorbing device in the summer and as a heat emitting device in the winter) heat generation in the power transistor using the thermoelement upon diagnosing.

An exemplary embodiment of the present invention provides a diagnostic and heat management system of a fuel cell stack. More specifically, a diagnostic control analyzer that is configured to diagnose and analyze a state of the fuel cell stack by measuring a voltage and a current of the fuel cell stack. An AC signal generator is configured to generate a diagnostic AC signal according to receiving a control command/signal from the diagnostic control analyzer. An AC component driving element may be driven according to an AC signal that is output from the AC signal generator to include an AC component for diagnostic in a current of the fuel cell stack. Also, a thermoelement may operate as a heat absorbing device t when the temperature of the AC component driving element is equal to or greater than a predetermined temperature, and may operate as a heat emitting device when a temperature of the AC component driving element is less than a predetermined temperature, in order to manage a heat generation in the AC component driving element. As such, in some exemplary embodiments of the present invention, the AC component driving element may be a power transistor.

Additionally, the diagnostic and heat management system may further include a thermoelement controller that controls the thermoelement, and a temperature sensor may detect the temperature of the power transistor. In such embodiments, the thermoelement controller may control the thermoelement based on the temperature of the power transistor that is detected by the temperature sensor.

In particular, the thermoelement controller may operate the thermoelement as a heat absorbing device when a temperature of the power transistor that is detected by the temperature sensor is equal to or greater than a predetermined temperature and may operate the thermoelement as a heat emitting device, when a temperature of the power transistor that is detected by the temperature sensor is less than a predetermined temperature.

As described above, according to an exemplary embodiment of the present invention, by applying a diagnostic AC signal to a base of a power transistor so that a portion of a current of the fuel cell stack may flow in a sinusoidal waveform form through a power transistor, the fuel cell stack can economically be diagnosed without distortion of an AC current via a simple configuration. Also by efficiently managing heat generation (e.g., using the thermoelement as a heat absorbing device in summer and as a heat emitting device in winter) in the power transistor using a thermoelement upon running the diagnostic process, heat management can be efficiently performed while at the same time diagnosing the fuel cell stack.

### BRIEF DESCRIPTION OF THE DRAWINGS

FIG. 1 is a schematic diagram of a diagnostic system of a fuel cell stack according to an exemplary embodiment of the conventional art.

FIG. 2 is a schematic diagram of a diagnostic and heat management system of a fuel cell stack according to an exemplary embodiment of the present invention.

FIG. 3 is a graph illustrating operation of a diagnostic and heat management system of a fuel cell stack according to an exemplary embodiment of the present invention.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Additionally, it is understood that the below methods are executed by at least one controller (e.g., the diagnostic analyzer). The term controller refers to a hardware device that includes a memory and a processor. The memory is configured to store the modules and the processor is specifically configured to execute said modules to perform one or more processes which are described further below.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Furthermore, the terminology used herein is for the purpose of describing particular embodiments only and is not intended to be limiting of the invention. As used herein, the singular forms “a”, “an” and “the” are intended to include the plural firms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0,05%, or 0.01% of the stated value. Unless otherwise clear from the context, all numerical values provided herein are modified by the term “about.”

Like reference numerals designate like elements throughout the specification.

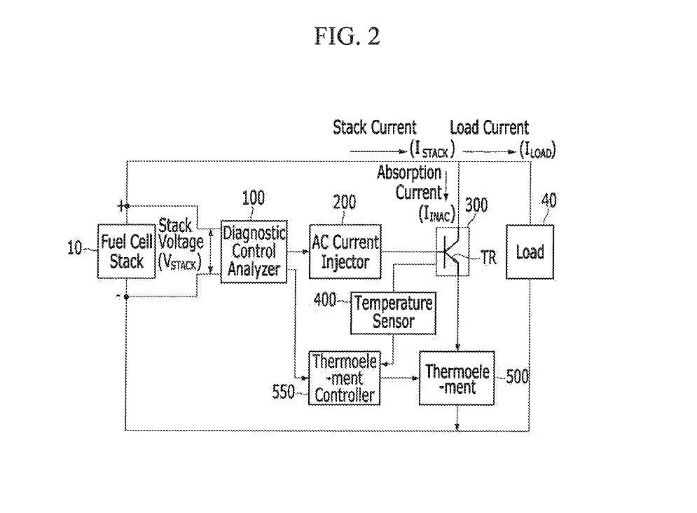

FIG. 2 is a schematic diagram of a diagnostic and heat management system of a fuel cell stack according to an exemplary embodiment of the present invention. A diagnostic and heat management system of a fuel cell stack according to an exemplary embodiment of the present invention is a system that efficiently manages a heat generation due to the diagnostic process while diagnosing the fuel cell stack.

The diagnostic and heat management system of a fuel cell stack according to an exemplary embodiment of the present invention includes a diagnostic control analyzer 100 configured to diagnose and analyze a state of the fuel cell stack 10 by measuring a voltage V_{STACK} and a current I_{STACK} of the fuel cell stack 10 and frequency of the voltage V_{STACK} and the current I_{STACK}; an AC signal generator 200 configured to generate a diagnostic AC signal I_{BASE} based on a command (e.g., signal) from the diagnostic control analyzer 100; and an AC component driving element 300 configured to be driven according to an AC signal that is output from the AC signal generator 200 to include an diagnostic AC component in a current I_{STACK} of the fuel cell stack 10. Also, a thermoelement 500 is operated a heat absorbing device when a temperature of the AC component driving element 300 is equal to or greater than a predetermined temperature and operates as a heat releasing device when a temperature of the AC component driving element 300 is less than a predetermined temperature, in order to manage a heat generation in the AC component driving element 300. Control of the thermoelement 500 is executed by a thermoelement controller 550 that includes specialized program instructions related to the control.

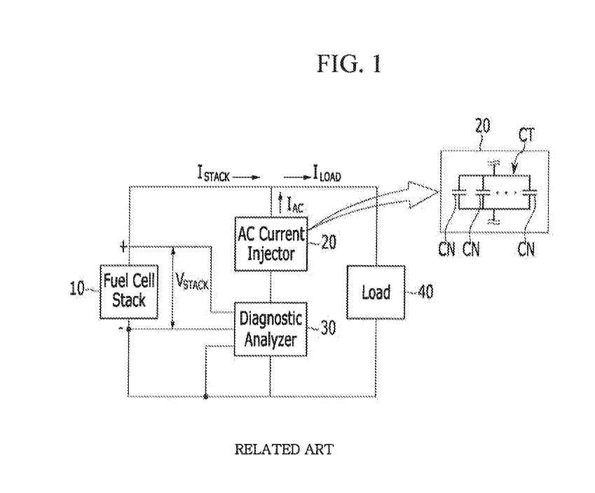

The diagnostic control analyzer 100 corresponds to the conventional diagnosis analyzer 30 (shown in FIG. 1). In the exemplary embodiment of the present invention, diagnostic control analyzer 100 may correspond to a conventional diagnostic analyzer 30 (as shown in FIG. 1). The diagnostic control analyzer 100 diagnoses the fuel cell stack 10 based on a current and a voltage received from the fuel cell stack 10 that includes an AC component via a load 40.

In an exemplary embodiment of the present invention, the AC component driving element 300 may be, for example, formed as a power transistor (TR). However, it should be understood that the present invention is not limited to merely power transistors and other components may be utilized. Thus, other configurations capable of substantially corresponding to the TR may be used in the present invention can be applied thereto.

In an exemplary embodiment of the present invention, the reason why the thermoelement 500 is included in the system is that a considerable amount of heat is generated upon operating the TR. Therefore, in the winter (e.g., when the temperature is less than a predetermined temperature), it is necessary to use the heat from the TR as a heating element, and in the summer (e.g., when the temperature is a predetermined temperature or more), it is necessary to cool the power transistor. For this purpose, an exemplary embodiment of the present invention may include a temperature sensor 400 that is configured to detect a temperature of the TR.

More specifically, when the temperature of the TR that is detected by the temperature sensor 400 is equal to or greater than a predetermined temperature, the thermoelement controller 550 operates the thermoelement 500 as a heat absorbing device, and when a temperature of the TR that is detected by the temperature sensor 400 is less than a predetermined temperature, the thermoelement controller 550 operates the thermoelement 500 as a heat emitting device.

The diagnostic control analyzer 100, the AC signal generator 200, and the thermoelement controller 550 may be formed with at least one processor operated via a predetermined program or hardware element included within the processor. As such, the diagnostic control analyzer 100, the AC signal generator 200, and the thermoelement controller 550 may be formed in an integrated body.

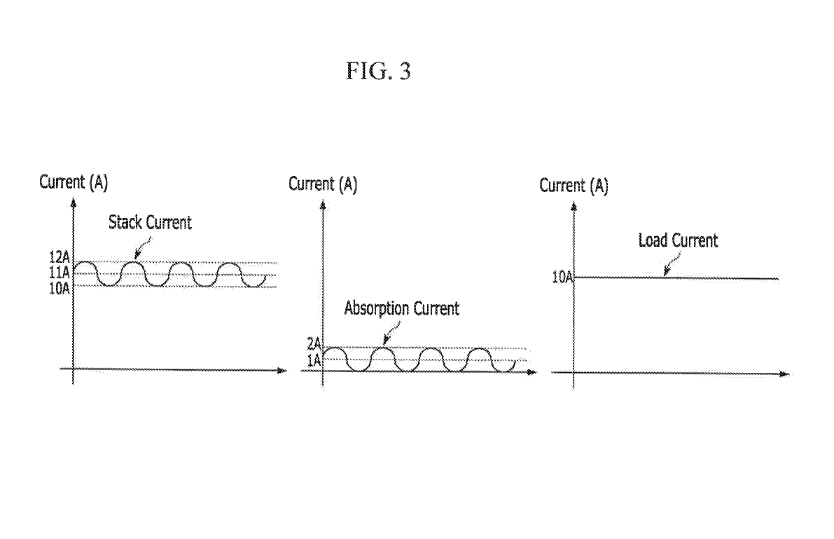

Hereinafter, operation of a diagnostic and heat management system of a fuel cell stack according to an exemplary embodiment of the present invention will be described in detail with reference to FIGS. 2 and 3.

When diagnosis of the fuel cell stack 10 is started, the AC signal generator 200 in generates an AC signal I_{BASE} so that an absorption current I_{INAC} may flow to the TR and applies the AC signal I_{BASE} to a base of the TR according to the control of the diagnostic control analyzer 100, as shown in FIG. 3. The AC signal I_{BASE} that is applied to the base of the TR is a current of an amplifying area and is controlled to flow to a base current by an amplifying ratio. When the AC signal generator 200 applies an AC signal I_{BASE} to the TR, an absorption current I_{INAC} flows to the TR and thus an AC component is included in a current I_{STACK} of the fuel cell stack 10, as shown in FIG. 3. Additionally, once the AC component is included in a current I_{STACK} of the fuel cell stack 10, an AC component is included in a load current I_{LOAD} flowing to the load 40.

As described above, as an absorption current I_{INAC} generates by driving of the TR, when an AC component (e.g., AC current) generates in a current I_{STACK} of the fuel cell stack 10, the diagnostic control analyzer 100 analyzes a frequency of a current and/or a voltage of the fuel cell stack 10 in which the AC component is included through a general diagnostic method and diagnoses a failure and/or a state of the fuel cell stack 10.

A method of diagnosing a fuel cell stack through a current and/or a voltage of a fuel cell stack in which the AC component (e.g., AC current) is included may follow a general method or a method that is well known in the art and thus a discussion of which will be omitted.

As described above, when diagnosis of the fuel cell stack 10 is performed, the TR generates a heat due to its operation. The temperature of the TR is then detected by the temperature sensor 400, and the temperature of the TR that is detected by the temperature sensor 400 is input to the thermoelement controller 550.

When a temperature of the TR that is detected by the temperature sensor 400 is equal to or greater than a predetermined temperature (e.g., about 30° C.), the thermoelement controller 550 may be configured to control the thermoelement 500 to absorb heat generated in the TR, thereby cooling a periphery. In some exemplary embodiments, the thermoelement controller 550 may be controlled by the diagnostic control analyzer 100.

Alternatively, when a temperature of the TR that is detected by the temperature sensor 400 is less than a predetermined temperature (e.g., about 5° C.), by operating the thermoelement 500 as a heat emitting device, the thermoelement controller 550 raises the temperature of a periphery together with a heat generation by the TR. Additionally, in some embodiments, the thermoelement controller 550 may not operate the thermoelement 500 in a predetermined temperature range (e.g., about 5° C.-about 30° C.).

Thereby, according to an exemplary embodiment of the present invention, by applying a diagnostic AC signal to a base of a power transistor so that a portion of a current of a fuel cell stack can flow in a sinusoidal waveform through the power transistor, a fuel cell stack can be economically diagnosed without distortion of an AC current via a simple configuration and upon executing the diagnostic process, by efficiently managing heat generation (e.g., using a thermoelement as a heat absorbing device in the summer and as a heat emitting device in the winter) in the power transistor by using a thermoelement, during the fuel cell stack diagnosis, heat management can be efficiently performed.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

<Description of symbols>

| | |
|---|---|
| 10: fuel cell stack | 100: diagnostic control analyzer |
| 200: AC signal generator | 300: AC component driving element |
| 400: temperature sensor | 500: thermoelement |
| 550: thermoelement controller | TR: power transistor |

What is claimed is:

1. A diagnostic and heat management system of a fuel cell stack, comprising:
a diagnostic control analyzer configured to diagnose and analyze a state of the fuel cell stack by measuring a voltage and a current of the fuel cell stack;
an AC signal generator configured to generate a diagnostic AC signal upon receiving a control command from the diagnostic control analyzer; and
an AC component driving element configured to be driven according to the diagnostic AC signal that is output from the AC signal generator to include a diagnostic AC component within the current from the fuel cell stack; and
a thermoelement driven as a heat absorbing device when a temperature of the diagnostic AC component driving element is equal to or greater than a first predetermined temperature and is driven as a heat emitting device when a temperature of the diagnostic AC component driving element is less than a second predetermined temperature.

2. The diagnostic and heat management system of claim 1, wherein the AC component driving element is a power transistor.

3. The diagnostic and heat management system of claim 2, further comprising a controller that controls the thermoelement.

4. The diagnostic and heat management system of claim 3, further comprising a temperature sensor configured to detect a temperature of the power transistor, wherein the thermoelement controller controls the thermoelement based on a temperature of the power transistor that is detected by the temperature sensor.

5. The diagnostic and heat management system of claim 4, wherein the thermoelement controller operates the thermoelement as a heat absorbing device when a temperature of the power transistor that is detected by the temperature sensor is equal to or greater than a predetermined temperature and operates the thermoelement as a heat emitting device when a temperature of the power transistor that is detected by the temperature sensor is less than a predetermined temperature.

6. A diagnostic and heat management method for a fuel cell stack, comprising:
diagnosing and analyzing, by a processor, a state of the fuel cell stack by measuring a voltage and a current of the fuel cell stack;
generating, by an AC signal generator, a diagnostic AC signal upon receiving a control signal from the diagnostic control analyzer;
driving an AC component driving element upon receiving the diagnostic AC signal that is output from the AC signal generator to include a AC component within the current from the fuel cell stack; and
detecting, by a sensor, a temperature of the AC component driving element, wherein a thermoelement is driven as a heat absorbing device when the temperature of the AC component driving element is equal to or greater than a first predetermined temperature and is driven as a heat emitting device when the temperature of the AC component driving element is less than a second predetermined temperature.

7. The diagnostic and heat management method of claim 6, wherein the AC component driving element is a power transistor.

8. The diagnostic and heat management method of claim 7, further comprising controlling the thermoelement via a controller.

9. The diagnostic and heat management system of claim 8, further comprising turning off the thermoelement when the temperature detected by the sensor is less the first predetermined temperature and greater than the second predetermined temperature.

10. A non-transitory computer readable medium containing program instructions executed by a processor, the computer readable medium comprising:
program instructions that diagnose and analyze a state of the fuel cell stack by measuring a voltage and a current of the fuel cell stack;
program instructions that generate a diagnostic AC signal upon receiving a control command; and
program instructions that drive an AC component driving element by generating the diagnostic AC signal that is output from the AC signal generator to include an AC component for diagnosis in the current from the fuel cell stack; and
program instructions that drive a thermoelement as a heat absorbing device when a temperature of the AC component driving element is equal to or greater than a first predetermined temperature and drives the thermoelement as a heat emitting device when the temperature of the AC component driving element is less than a second predetermined temperature.
